(19) United States
(12) Patent Application Publication
(10) Pub. No.: US 2016/0233757 A1
(43) Pub. Date: Aug. 11, 2016

(54) LOW LEVEL HARMONICS CONTROL SYSTEM FOR GROUPS OF IMPEDANCES CONNECTED IN PARALLEL IN A THREE-PHASE SYSTEM

(71) Applicant: SOLARONICS S.A., Armentières (FR)

(72) Inventor: Arnaud MEAUSOONE, Godewaersvelde (FR)

(73) Assignee: SOLARONICS S.A., Armentieres (FR)

(21) Appl. No.: 15/021,838

(22) PCT Filed: Oct. 28, 2014
(86) PCT No.: PCT/EP2014/073083

§ 371 Date: Mar. 14, 2016

(30) Foreign Application Priority Data
Dec. 11, 2013 (EP) 13290309.7

(51) Int. Cl. H02M 1/12; H05B 37/02; H02M 5/257

(52) U.S. Cl. CPC H02M 1/12; H02M 5/2576; H05B 37/0209

(57) ABSTRACT

A control system for control of supply of electrical power from a network to various groups of impedances comprises a synchronisation system for synchronising with the cycles of an AC supply network and a programmable control unit. The programmable control unit has control tables. Each control table corresponds with a particular percentage of maximum electrical power. Each control table has a sequence of bits, the percentage of 1 values corresponds to the percentage of maximum power. The programmable control unit provides digital outputs in the form of control tables for the command of static power switches which control electrical power to the various groups of impedances. The impedances of one group are connected in star and the various groups are connected in parallel. The control system guarantees an efficient use of the electrical power, equally distributed over the three phases with a low level of harmonics.

### TECHNICAL FIELD

The invention relates to a control system for control of supply of electrical power from a network to various groups of impedances. The invention also relates to the use of such a control system in a non-contact drying system.

### BACKGROUND ART

A control system for supply of electrical power from a network to electrical resistors is known from U.S. Pat. No. 5,053,604.

This prior art control system discloses a process and a device for the control of heating of a furnace by means of electrical resistors. Switching devices such as thyristors are being used. The switching devices are controlled in a syncopated mode by an industrial computer, a logic controller or some equivalent device. A control table with digital values “1” and “0” is being generated by the industrial computer or the like and is being used in a synchronised way as logical control (on-off) of the thyristors.

The prior art control system of U.S. Pat. No. 5,053,604, however, is designed for controlling industrial furnaces, and, more particularly, glassmaking furnaces. The heating of glass sheets for tempering and bending needs to be controlled within very narrow ranges. As a result, U.S. Pat. No. 5,053,604 discloses measures to adapt for fluctuations in the electrical power as provided by the supply net.

Industrial furnaces with electrical resistors, such as in U.S. Pat. No. 5,053,604, have a great time constant or a high thermal inertia, so that the need for a quickly reacting control system is not present.

In addition, the electrical connection used in U.S. Pat. No. 5,053,604 is an open delta (triangle) connection, which does not generate a high level of harmonics so that the need for avoiding harmonics is not present.

Moreover, the electrical scheme of U.S. Pat. No. 5,053,604 only uses two phases and not the three phases.

EP-A1-0 040 017 discloses a control system for control of supply of electrical power from a network to various groups of impedances. The control system comprises a programmable control unit. The impedances are connected in star and the groups are connected in parallel.

DE-A1-33 04 322 discloses an electrical water heater. The electrical power from the network is proportional to the volume flow of water.

### DISCLOSURE OF INVENTION

The primary object of the invention is to provide a control system for control of supply of electrical power to a wider variety of impedances.

It is a particular object of the invention to control the electrical power to a group of impedances with a small time constant or low thermal inertia.

It is another object of the invention to provide a control system which allows to reduce harmonics.

It is yet another object of the invention to provide a control system which makes full and optimal use of a three phase electrical supply network.

According a first aspect of the invention there is provided a control system for control of supply of electrical power from a network to various groups of impedances. The control system comprises a synchronisation system for synchronising with the cycles, i.e. the frequency, of a supply network. The control system further comprises a programmable control unit. The programmable control unit has control tables. Each control table corresponds with a particular level of maximum electrical power and each control table has a sequence of bits (0 or 1) where the percentage of 1 values corresponds to the level of maximum power. The control programmable unit provides digital outputs in the form of one of these control tables for the command of static power switches which control electrical power to the various groups of impedances. The impedances within at least one group are connected in star, and the various groups of impedances are connected in parallel.

The feature of having various groups of impedances connected in parallel allows reducing harmonics.

The connection in star of the impedances within one group allows optimizing the electrical power.

According to a preferable embodiment, the impedances within at least one group are connected in star without connection to a neutral lead or neutral wire. This avoids a double cabling or double wiring.

According to another preferable embodiment, the synchronisation system generates a signal having cycles. The control unit further comprises pointers, one pointer per group of impedances, and each pointer is positioned on a control table and proceeds with one bit per cycle of said signal. A pointer for a following adjacent next group of impedances is on a position in the control table which is different than the pointer of the previous adjacent group. This difference in position is e.g. one bit.

This difference of position of pointers in different control tables avoids peaks in electrical currents and further reduces the level of harmonics.

In a most preferable embodiment, the signal of the synchronisation system has a phase difference with the supply network.

As will be explained hereinafter with reference to the drawings, this phase difference results in an equal power spreading over the three phases.

According to a practical embodiment, the signal of the synchronisation system is a square wave with a mounting side and a descending side and the above-mentioned pointers proceed with one bit per mounting side of said square wave.

According to another preferable embodiment, the 1 values in each control table are uniformly spread over the control table.

The advantage of this uniform spreading is apparent in case the impedances have a small time constant, which is the case for infrared lamps. The uniform spreading limits the so-called flickering of the lamps.

According to still another preferable embodiment, static power switches are only used in two of the three phases. This saves static power switches in one phase.

According to a second aspect of the invention, there is provided a non-contact drying system comprising a control system according to the first aspect of the invention. In the non-contact drying system the impedances are infrared lamps.

### BRIEF DESCRIPTION OF FIGURES IN THE DRAWINGS

FIG. 1a illustrates the synchronisation system of the control system according to the invention and FIG. 1b illustrates a phase difference between the cycles of a synchronisation signal and a supply network;

FIG. 2 illustrates the control system according to the invention;

FIG. 3 shows curves of voltages and currents over a star connection of three infrared lamps.

FIG. 4 shows a preferred embodiment of a power supply towards one group of impedances.

FIG. 5a, FIG. 5b and FIG. 5c show curves of voltages and currents over the embodiment of FIG. 4.

### MODES(S) FOR CARRYING OUT THE INVENTION

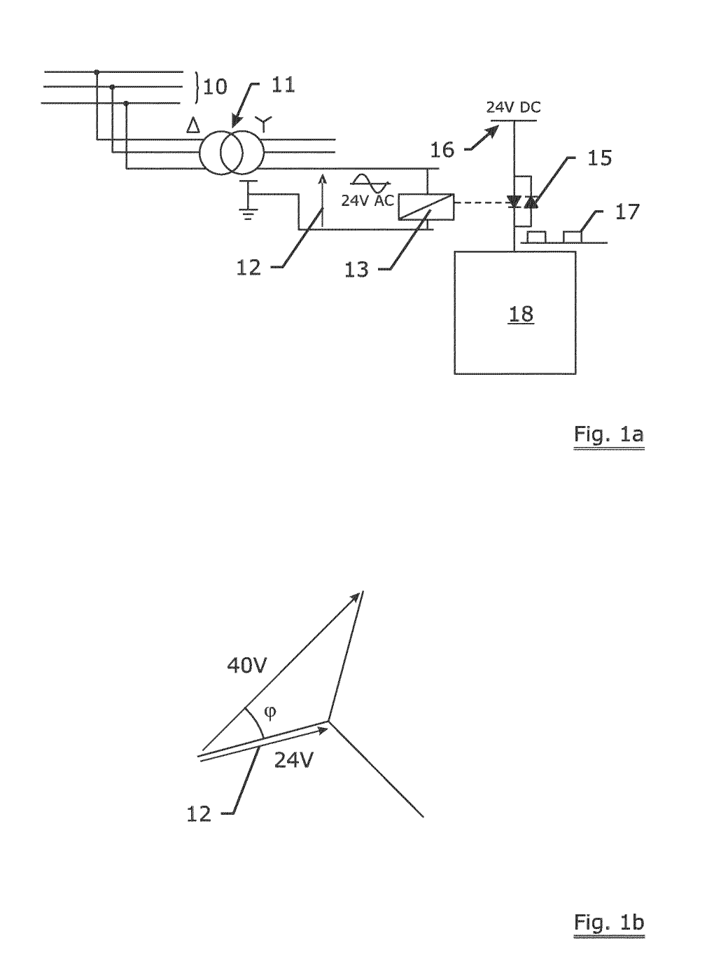

FIG. 1a illustrates the synchronisation system of the control system of the invention. A three-phase supply network 10 of electrical power (400 V, AC) is connected to a delta-star transformer 11 with neutral connection. The transformer voltage ratio is 1/10 so that the outcome voltage of the transformer is 40 V, AC. The voltage 12 between the neutral and a phase is 40/\sqrt{3}=23.1 V AC or about 24 V. This voltage 12 is fed to a static command switch 13 which commands solid static relays 15. These solid static relays 15 are being fed by a 24 V direct current, and this generates a square wave 17 with amplitude 24 V and a frequency which is equal to the frequency of the supply network 10. Due to the fact that the AC voltage 12 is taken between the neutral and a phase, there is a phase difference φ of 30° between the voltage 12 and the supply network 10. This is illustrated in FIG. 1b. This phase difference φ is also existing between the synchronisation square wave 17 and the supply network 10. The advantage of this phase difference will be explained hereinafter. The synchronisation square wave signal 17 has a mounting side and a descending side.

18 is the synchronised PLC input.

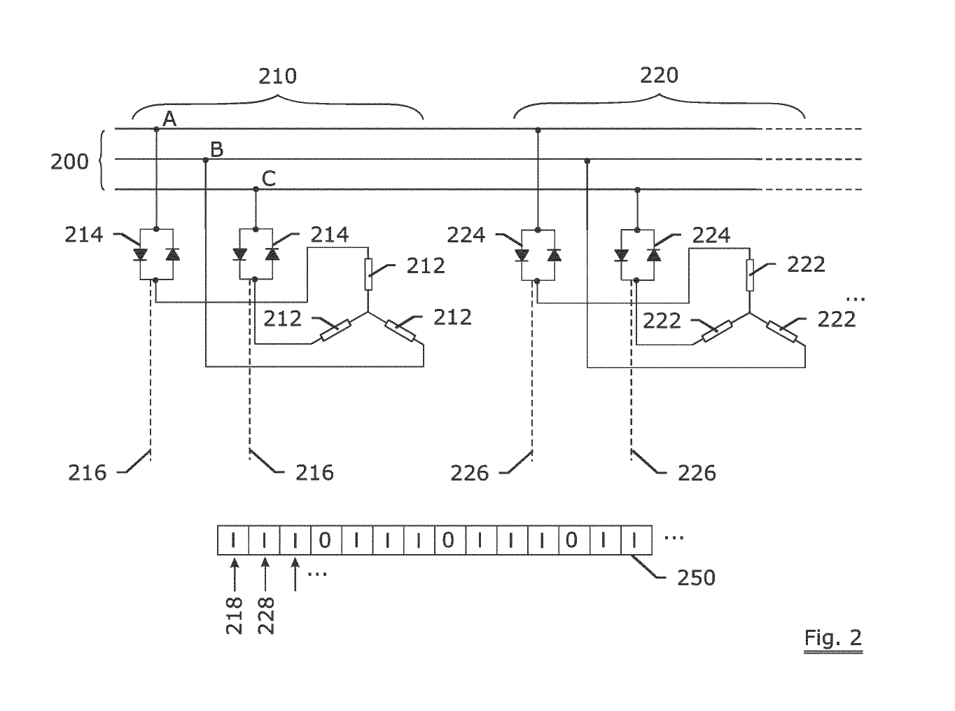

FIG. 2 illustrates (part of) the control system according to the invention. A three-phase supply network 200, which is usually the same supply network as in FIG. 1, supplies electrical power to a non-contact dryer and profiler. Non-contact drying is done by means of infrared lamps. The infrared lamps are divided in various groups 210, 220, . . . For example, there can be three infrared lamps 212 in group 210, three infrared lamps 222 in group 220, and so on. The number of infrared lamps per group can also be a multiple of three: six, nine . . .

Each group 210, 220 of infrared lamps 212, 222 is connected in parallel to the supply network 200.

Inside each group 210, 220, the infrared lamps 212, 222 are connected in star without a connection to a neutral lead or neutral wire.

Static power switches such as power thyristors 214, 224 on phases A and C determine the electrical currents to the infrared lamps 212, 222.

The static power switches 214, 224 receive a digital input signal 216, 226. The signal is digital, which means that a “0” stands for off and a “1” for on. The value of the digital input signal 216, 226 is determined by the position of a pointer 218, 228 on a control table 250. Pointer 218 is associated with the first group of infrared lamps 212. Pointer 228 is associated with the second group of infrared lamps 222. Pointer 228 is shifted with one bit with respect to the position of pointer 218. Every pointer proceeds with one bit per each mounting side of the synchronisation square wave 17. The shifting of each pointer per group of infrared lamps limits the peaks in electrical currents.

There are 101 control tables 250. Each control table corresponds with a power level between 0% and 100%: 0%, 1%, 2%, . . . , 99%, 100%. Each table has e.g. 256 bits. The percentage of 1 values corresponds to the percentage of maximum power level. The table of 0% has only 0 values: 00000000 . . .

The table of 50% has 50% 0 values and 50% 1 values: 11001001100 . . .

The table of 75% has 75% 1 values: 1110111011101110 . . .

The table of 100% has only 1 values: 111111111111111 . . .

Most preferably the 1 values are uniformly spread in a control table, since this reduces the flickering effect of the infrared lamps.

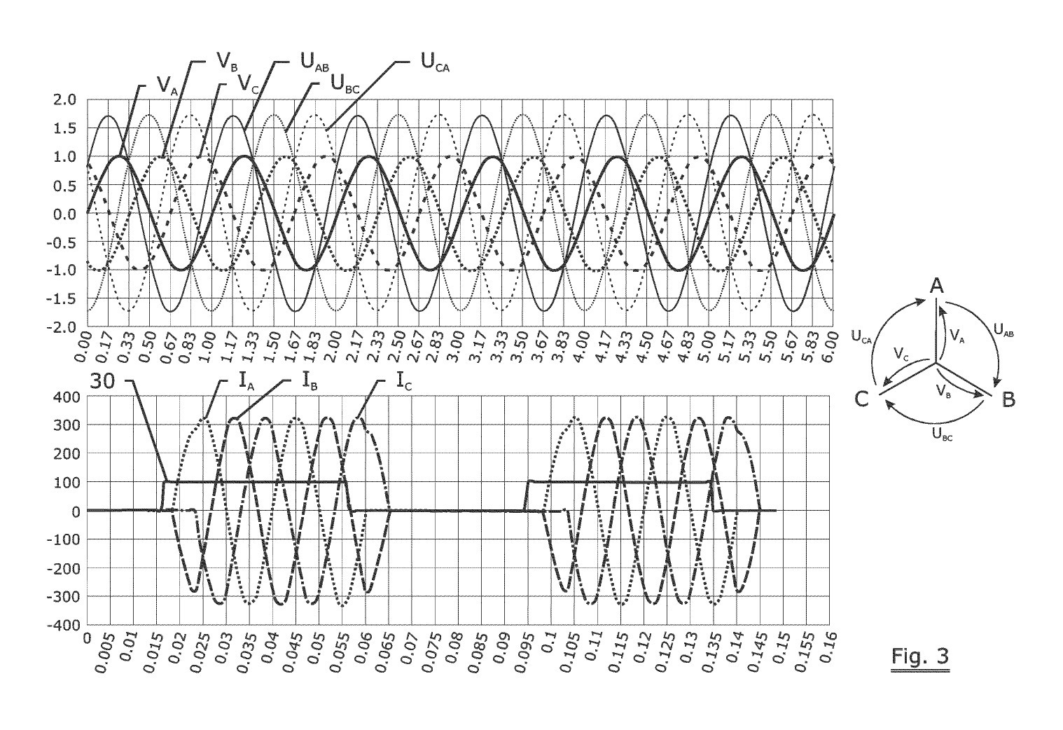

FIG. 3 shows curves of voltages and currents over a star connection of three infrared lamps over four periods.

The curves in the upper half are the curves of the voltages, which are all sinusoidal.

Curves U_{AB}, U_{BC} and U_{CA} are resp. the voltages between the points A-B, B-C and C-A on FIG. 2.

Curves V_{A}, V_{B} and V_{C} are resp. the voltages between the middle of the start and A, the middle of the star and B and the middle of the star and C.

Looking at the curves in the lower half, curve 30 is the command signal. The power thyristors 214 only conduct in case the corresponding voltage V_{A}, V_{B} or V_{C} cross the zero Volt and the command signal 30 has a positive value. The electrical currents thus generated are represented by curves I_{A}, I_{B} and I_{C} resp.

These electrical currents are not sinusoidal and each electrical current, taken alone, generates harmonics. However, due to the fact that various groups, e.g. ten groups, of infrared lamps are connected in parallel the global effect of harmonics is reduced.

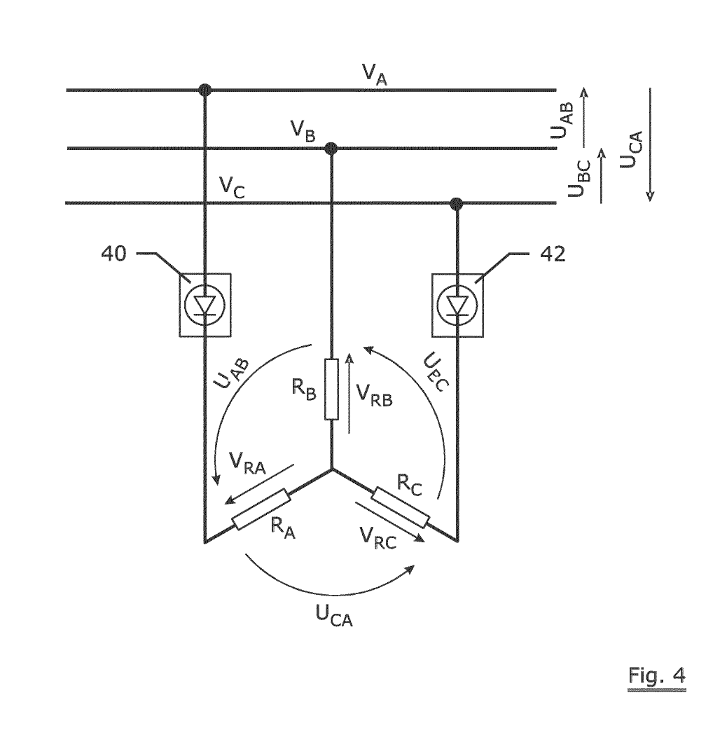

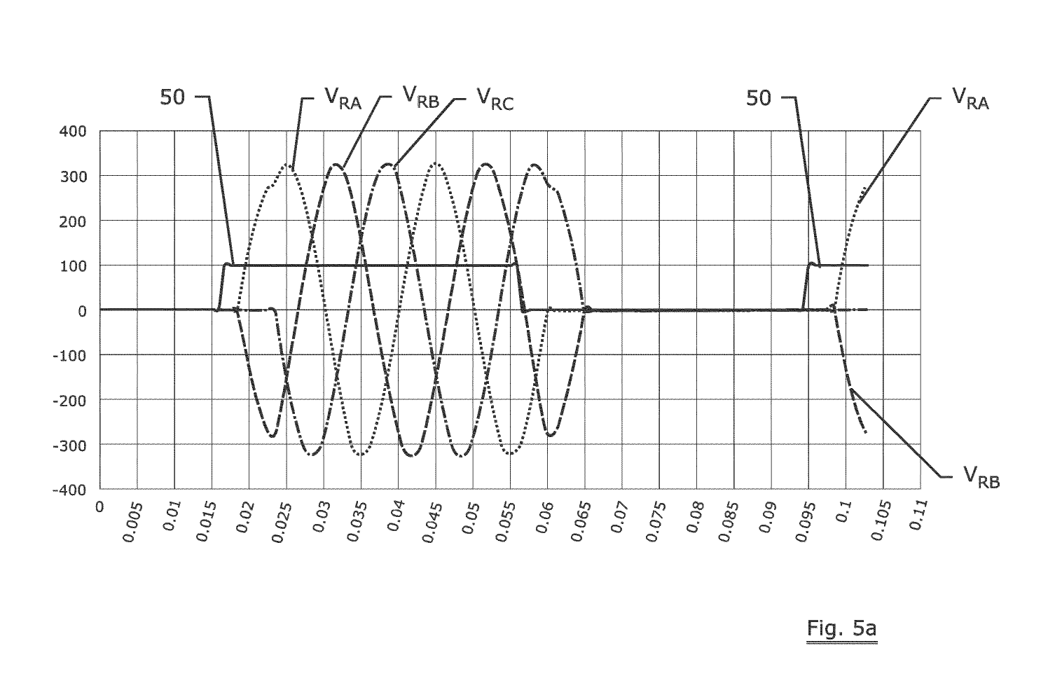

FIG. 4 shows a preferred embodiment of a power supply towards one group of impedances. As is the case with the embodiment of FIG. 2, the embodiment of FIG. 4 has the advantage that it has only two static relays 40 and 42.

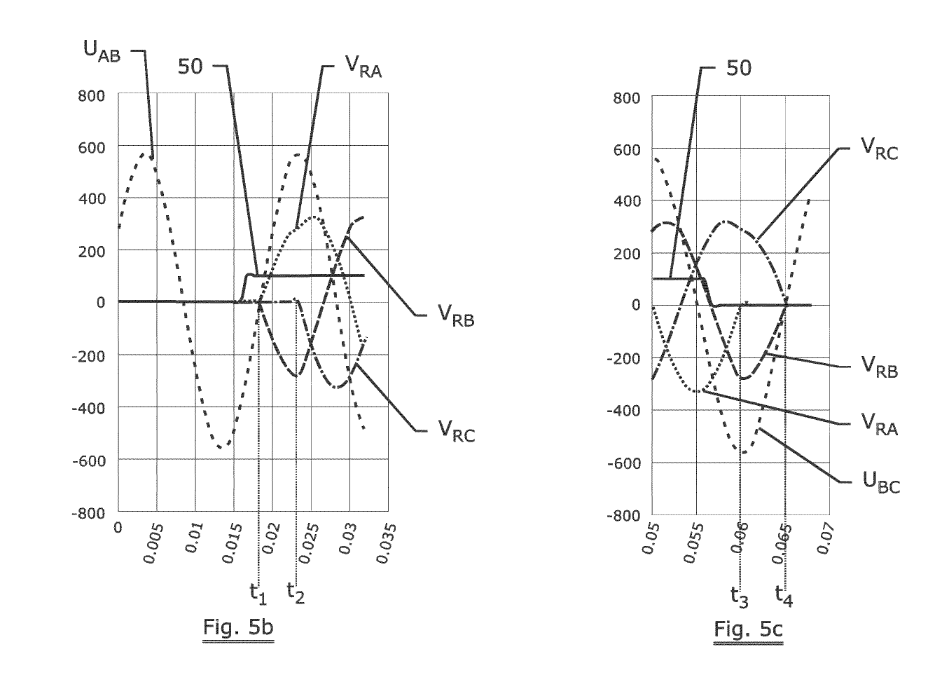

FIG. 5a shows curves of voltages and currents over the embodiment of FIG. 4.

The power supply network is a three phase network with 400 VAC and 50 Hz. Phases A and C are supplied over a static relay, phase B is directly supplied. The three infrared lamps to be supplied have impedances R_{A}, R_{B} and R_{C}. These infrared lamps have a nominal power of 3000 W under 235 VAC. In this example the command signal 50 corresponds to 50% of the maximum power and has as control table 110011001100 . . . The joint command signal 50 for both static relays 40 and 42 is a square wave 50 with a positive signal during 40 msec followed by a zero signal during 40 msec.

V_{RA}, V_{RB} and V_{RC} are the voltages over resp. the impedances R_{A}, R_{B} and R_{C} of the three infrared lamps. The power obtained for each infrared lamp is:

P_{A}=1501 W

P_{B}=1490 W

P_{C}=1501 W

So the power for each infrared lamp is more or less equal. In order to obtain this uniform distribution of power, it is important to avoid that the mounting sides of the command signal 50 coincide with the passage through zero of the voltages U_{AB} and U_{BC}. As explained with reference to FIG. 1a and FIG. 1b, this may be obtained by cabling the static command switch of the synchronisation system at the secondary site of a delta star transformer between one phase and a neutral. In this way a phase difference φ is created between the square wave 17 of the synchronisation system and the voltages U_{AB}, U_{BC} and U_{CA}. This phase difference avoids the simultaneous starting of the mounting side of the square wave 17 and the passage through zero of U_{AB} and U_{BC}. Suppose the phase difference φ is not present, the minor delay of the square wave 17 may result in a static relay or power switch staying off instead of switching on, or vice versa.

FIG. 5b shows in more detail when the 1^{st} static relay 40 and the 2^{nd} static relay 42 and the three impedances R_{A}, R_{B} and R_{C} start to conduct.

The 1^{st} static relay 40 starts to conduct from t₁ on at a time when the voltage U_{AB} passes through zero and the command signal 50 is positive. The voltage over R_{A} is then equal to U_{AB}/2 and over R_{B} equal to −U_{AB}/2.

From t₂ on, at a time when V_{C} passes through zero, the 2^{nd} static relay 42 starts to conduct. From t₂ on the three impedances R_{A}, R_{B} and R_{C} are fed in all three phases.

Referring to both FIG. 5b and FIG. 5c, the three impedances R_{A}, R_{B} and R_{C} are fed in all three phases between t₂ and t₃.

FIG. 5c shows in more detail when the 1^{st} static relay 40 and the 2^{nd} static relay 42 and the three impedances R_{A}, R_{B} and R_{C} stop to conduct.

At t₃ V_{A} passes through zero at a moment when the command signal 50 has already turned to zero. The 1^{st} static relay 40 stops to conduct. The 2^{nd} static relay 42 continues to conduct until t₄. The voltage over R_{C} is equal to −U_{BC}/2 and the voltage over R_{B} is equal to U_{BC}/2.

At t₄, at a time when U_{BC} passes through zero and the command signal 50 is zero, the 2^{nd} static relay also stops to conduct.

As may be derived from FIG. 5a, apart from the start period t₁-t₂ and the stop period t₃-t₄, the signals are very close to a sinusoidal form so that the level of harmonics is limited.

In addition, and as already mentioned, since various groups of impedances are cabled in parallel, the effect of harmonics is further minimized.

### TABLE WITH REFERENCE NUMBERS AND SYMBOLS

10 electric power supply network
11 transformer
12 voltage between neutral and one phase
13 static command switch
15 solid static relays
16 24 DC voltage
17 synchronisation square wave
18 synchronisation input PLC
Y star connection
Δ delta connection
φ phase difference 200 electric supply network
210 first group of infrared lamps
212 infrared lamp
214 power thyristors
216 digital input signal
218 pointer on control table
220 second group of infrared lamps
222 infrared lamp
224 power thyristors
226 digital input signal
228 pointer on control table
250 control table
30 command signal
40 1^{st} static relay
42 2^{nd} static relay
50 command signal
U_{AB} voltage between A and B
U_{BC} voltage between B and C
U_{CA} voltage between C and A
V_{A} voltage on A
V_{B} voltage on B
V_{C} voltage on C
I_{A} current through infrared lamp of phase A
I_{B} current through infrared lamp of phase B
I_{C} current through infrared lamp of phase C
R_{A} impedance of infrared lamp
R_{B} impedance of infrared lamp
R_{C} impedance of infrared lamp
V_{RA} voltage over impedance R_{A}
V_{RB} voltage over impedance R_{B}
V_{RC} voltage over impedance R_{C}

1-9. (canceled)

10. A control system for control of supply of electrical power from a network to various groups of impedances,
said control system comprising a synchronisation system for synchronising with the cycles of an AC supply network,
said control system further comprising a programmable control unit,
said programmable control unit having control tables,
each control table corresponding with a particular percentage of maximum electrical power,
each control table having a sequence of bits (0 or 1), the percentage of 1 values in each control table corresponding to the percentage of maximum power,
said programmable control unit providing digital outputs in the form of said control tables for the command of static power switches which control electrical power to said various groups of impedances,
the impedances within at least one group being connected in star,
the various groups being connected in parallel.

11. The control system according to claim 10,
where the impedances within said at least one group are connected in star without connection to a neutral lead or neutral wire.

12. The control system according to claim 10,
wherein said synchronisation system generates a signal having cycles, and wherein said control unit further comprises pointers,
one pointer per group of impedances,
each pointer being positioned on a control table and proceeding with one bit per cycle of said signal,
a pointer for a following adjacent next group of impedances being on a position in the control table which is different than the pointer of the previous adjacent group.

13. The control system according to claim 12,
wherein said signal has a phase difference with the supply network.

14. The control system according to claim 13,
wherein said signal is a square wave with a mounting side and a descending side and wherein said each pointer proceeds with one bit per mounting side of said square wave.

15. The control system according to claim 10,
wherein the ‘1’ values in each control table are uniformly spread over said control table.

16. The control system according to claim 10,
wherein said impedances are infrared lamps.

17. The control system according to claim 10,
wherein static power switches are used in only two of the three phases.

18. The non-contact drying system comprising a control system according to claim 10.

19. The control system according to claim 11,
wherein said synchronisation system generates a signal having cycles, and wherein said control unit further comprises pointers,
one pointer per group of impedances,
each pointer being positioned on a control table and proceeding with one bit per cycle of said signal,
a pointer for a following adjacent next group of impedances being on a position in the control table which is different than the pointer of the previous adjacent group.
